(19) United States
(12) Patent Application Publication
(10) Pub. No.: US 2002/0003375 A1
(43) Pub. Date: Jan. 10, 2002

(54) Detachable wheel assembly of luggage

(75) Inventor: Chung-Hsien Kuo, Pan-Chiao City (TW)

Correspondence Address: Dougherty & Troxell, ONE SKYLINE PLACE, 5205 LEESBURG PIKE, SUITE 1404, FALLS CHURCH, VA, 22041, US

(73) Assignee: CHAW KHONG TECHNOLOGY CO. LTD.

(21) Appl. No.: 09/824,743

(22) Filed: Apr. 4, 2001

(30) Foreign Application Priority Data
Jul. 6, 2000 (TW) 089211670

(51) Int. Cl. B60B 35/00

(52) U.S. Cl. 301/111.01

(57) ABSTRACT

A detachable wheel assembly of luggage comprises a bracket, a wheel unit mounted to bottom of the bracket, and a screw wherein the claw of the wheel unit is snapped into the slot of the bracket and the screw is driven through the wheel unit to the bracket in the rear to secure them together. By utilizing this, the detachment of wheel is achieved by simply unscrewing the screw from the wheel assembly, thus facilitating the replacement of wheel.

### BACKGROUND OF THE INVENTION

1. Field of the Invention

The present invention relates to wheels, and more particularly to a detachable wheel assembly of luggage.

2. Description of Related Art

It is recognized that wheels are the most important components of a wheeled luggage. This is because all weight of luggage is borne on wheels. As such, wheel malfunctions are frequently occurred. Replacement of wheel is also known as tedious. This is because wheel is typically secured to the bottom of luggage by threading through inner and outer wheel mounts from inside and outside of luggage respectively wherein one pair of screws are driven from inside toward outside, while the other pair of screws are driven from outside toward inside. In view of this, it is required to unfasten screws from inside and outside respectively in order to replace the worn-out or malfunctioned wheel. To the worse, it is inevitable to dismantle the interior lining of luggage while unfastening screws. As a result, the interior lining is damaged and may not be recovered to its original form. It is deemed to be inconvenient.

U.S. Pat. Nos. 6,113,196 and 6,116,701 both disclose a detachable wheel assembly of luggage, the teachings of which are hereby incorporated by reference.

Thus, it is desirable to provide a detachable wheel assembly of luggage to overcome the above drawbacks of prior art.

### SUMMARY OF THE INVENTION

An object of the present invention is to provide a detachable wheel assembly of luggage wherein the detachment of a wheel is achieved by simply unscrewing a screw from the wheel assembly, thus facilitating the replacement of wheel.

Another object of the present invention is to provide a detachable wheel assembly of luggage wherein two resilient end caps are provided between the wheel axis and wheel mount for reducing noise.

Still another object of the present invention is to provide a detachable wheel assembly of luggage wherein the wheel axis comprises two resilient end caps for providing a degree of comfort to operator while towing on an uneven ground. To achieve the above and other objects, the present invention provide a detachable wheel assembly of luggage comprising a bracket, a wheel unit mounted to bottom of the bracket, and a screw wherein the claw of the wheel unit is snapped into the slot of the bracket and the screw is driven through the wheel unit to the bracket in the rear to secure them together.

The above and other objects, features and advantages of the present invention will become apparent from the following detailed description taken with the accompanying drawings.

### BRIEF DESCRIPTION OF THE DRAWINGS

FIG. 1 is an exploded perspective view of a wheel assembly of the present invention;

FIGS. 2A and 2B are an exploded plan and side views in part section schematically respectively wherein wheel unit is separated from wheel assembly;

FIG. 3 is an exploded plan view in part section of the wheel unit shown in FIG. 2;

FIG. 4 is a perspective view of the assembled wheel assembly of FIG. 1;

FIG. 5 is similar to FIG. 2A wherein wheel unit is assembled with wheel assembly; and

FIG. 6 is a side view of FIG. 5.

### DETAILED DESCRIPTION OF THE PREFERRED EMBODIMENTS

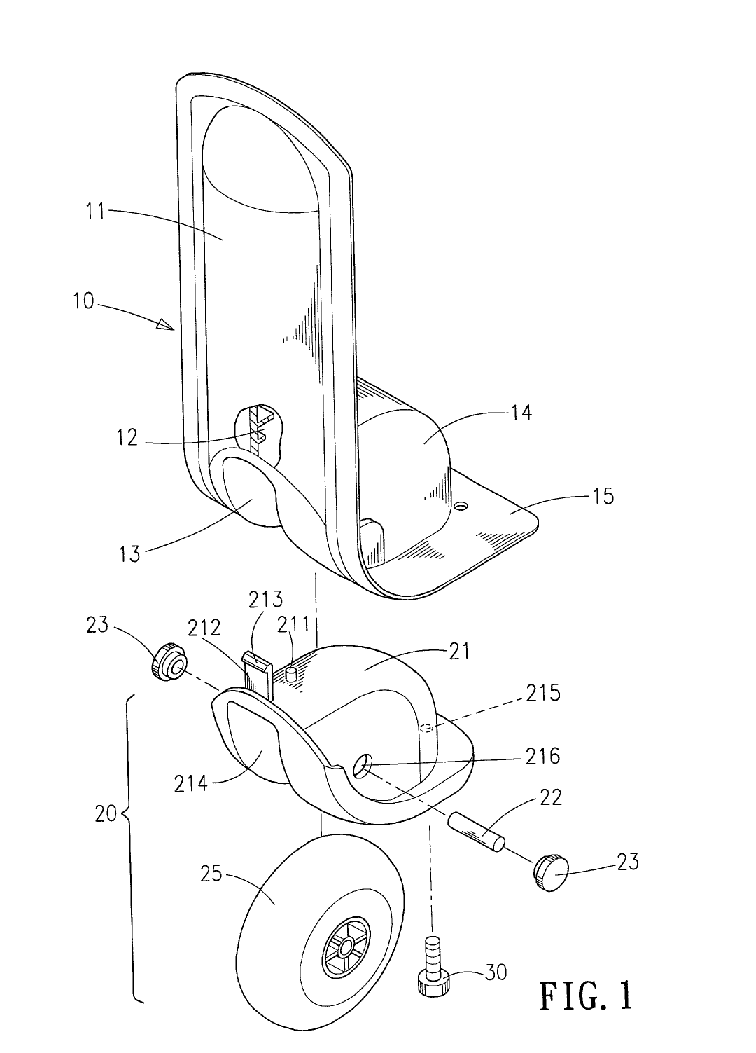

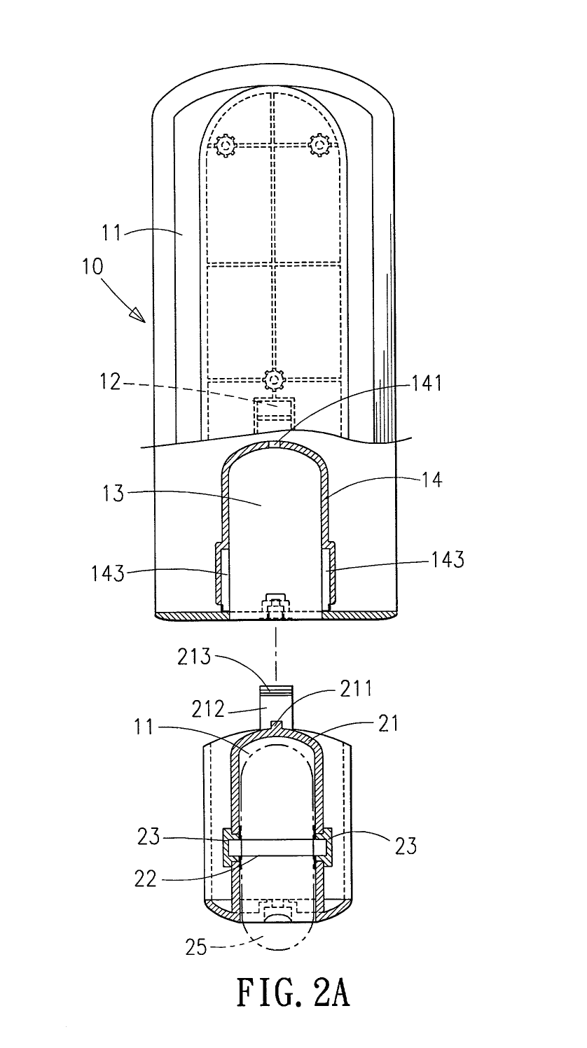

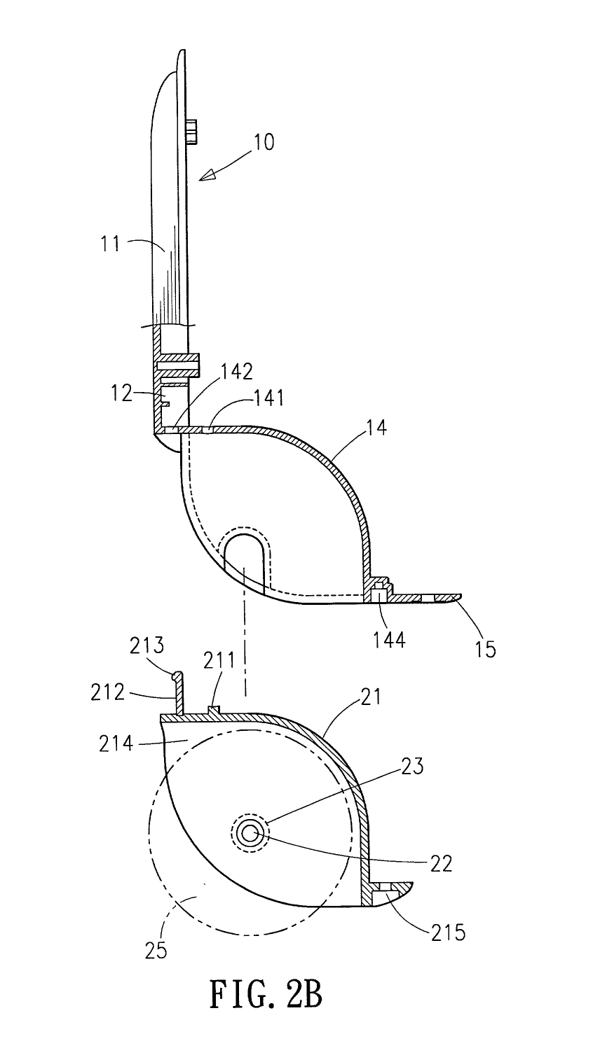

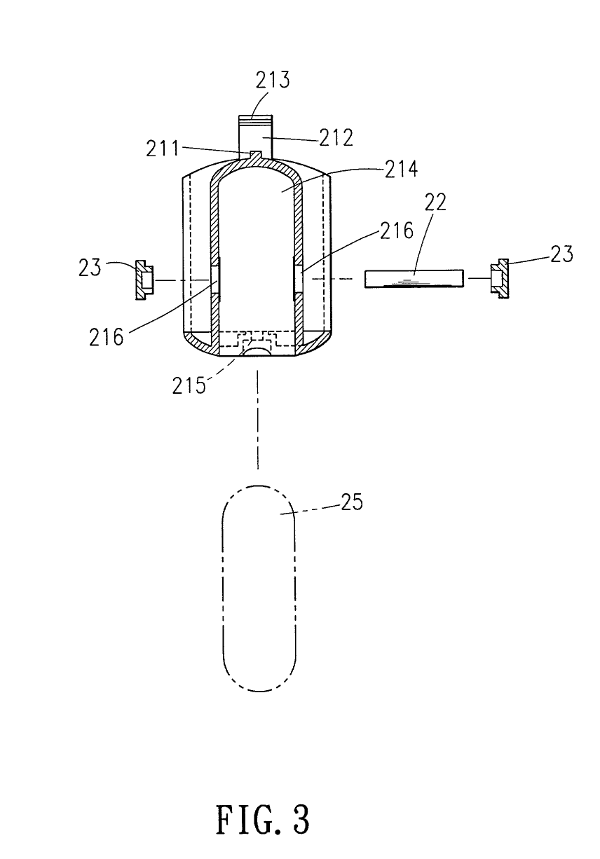

Referring to FIGS. 1 to 3, there is shown a detachable wheel assembly of luggage constructed in accordance with the invention. The wheel assembly comprises a bracket 10, a wheel unit 20 mounted to bottom of the bracket 10, and a screw 30. Bracket 10 comprises a vertical portion 11, a horizontal portion 15, a well 13 in the joining of vertical portion 11 and horizontal portion 15, a housing 14, a slot 12 inside the lower portion of the vertical portion 11, an elongate slit 142 below the slot 12, a hole 141 adjacent slit 142, an inside recess 143 on either side of housing 14, and a threaded hole 144 on the joining of housing 14 and horizontal portion 15. Wheel unit 20 comprises a housing 21, an axis 22, a resilient end cap 23 on either end of axis 22 buffered between aperture 216 and axis 22, and a wheel 25. Housing 21 is shaped to conform with well 13. Housing 21 comprises a stud 211 on the upper surface conformed to the hole 141, an extension 212 adjacent the stud 211, a claw 213 on the top of extension 212, a well 214 on the front, a threaded hole 215 on the rear, and an axis aperture 216 through either side of housing 21.

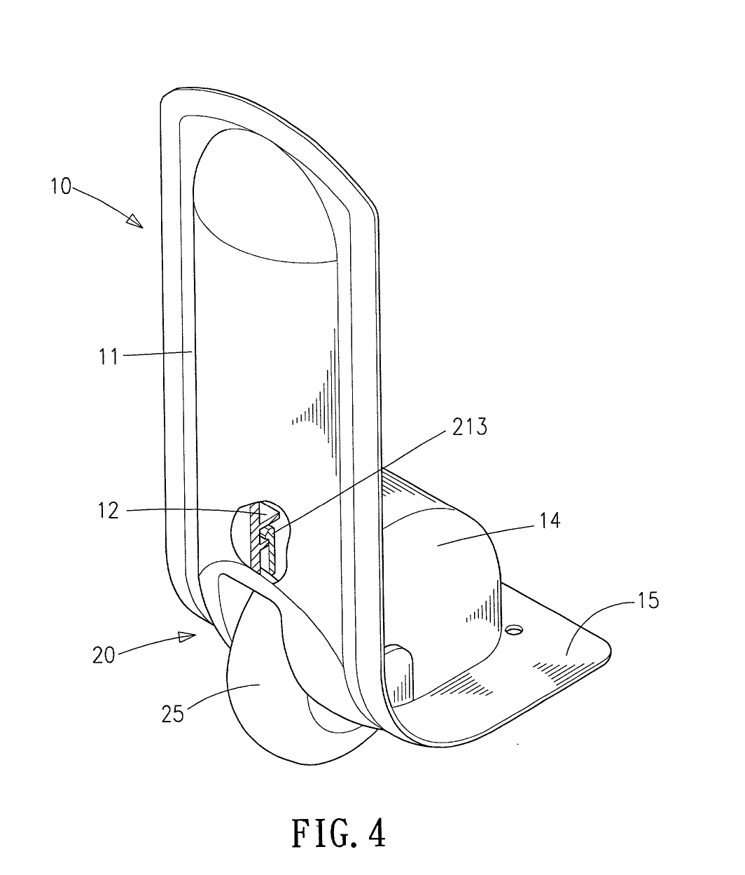

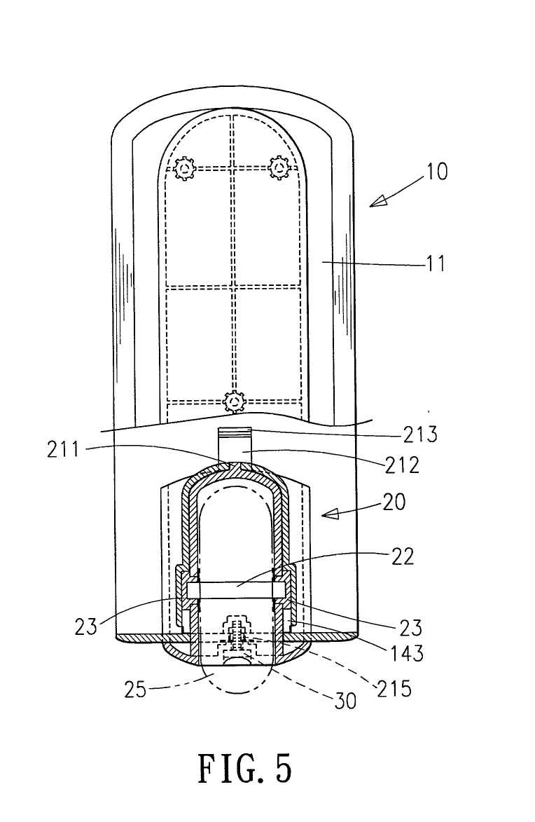

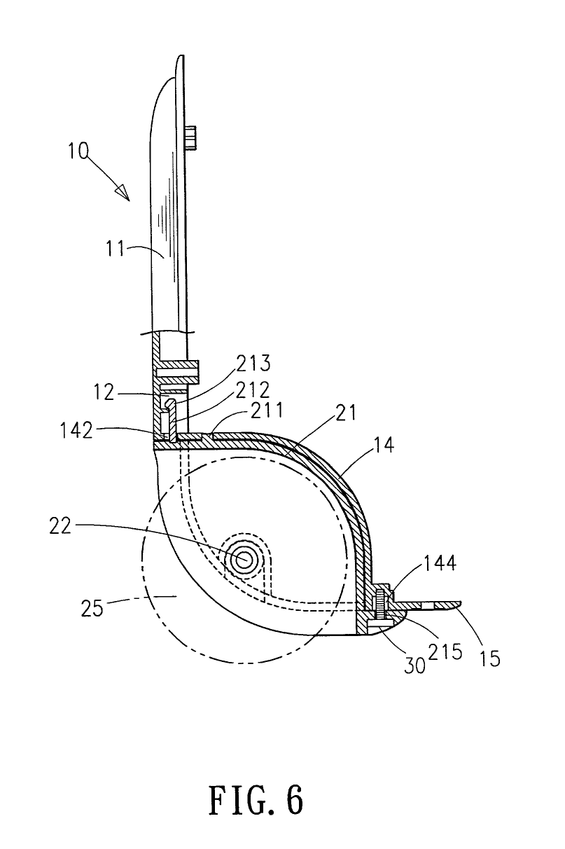

Referring to FIGS. 4 to 6, the assembly of the wheel assembly will now be described. First align the bore of wheel 25 with apertures 216. Then insert axis 22 through apertures 216 and the bore of wheel 25. Then secure axis 22 in hole 216 by means of resilient end cap 23 thus forming a wheel unit 20. Next, snap claw 213 into the slot 12 through the slit 142 and insert the stud 211 in the hole 141 respectively. The resilient end cap 23 is compressible due to its elasticity so as to be received in recess 143. Then drive screw 30 through threaded hole 215 and threaded hole 144 to secure wheel unit 20 to bracket 10. Thus assemble a complete wheel assembly.

The advantages of the invention are simple quick in wheel replacement, noise reduction, and a degree of comfort to operator while towing on an uneven ground due to the provision of resilient end caps.

While the invention herein disclosed has been described by means of specific embodiments, numerous modifications and variations could be made thereto by those skilled in the art without departing from the scope and spirit of the invention set forth in the claims.

What is claimed is:

1. A detachable wheel assembly of luggage comprising:
a bracket including a vertical portion, a horizontal portion, a well in a joining of the vertical portion and the horizontal portion, a housing, a female snapping
q₀=q₁+qₕ=qₛ+qₕ=q_{f}+qₕ
(2-2) heat transfer coefficient is expressed by the following portion;
(2-3) brief formula to heat transfer of natural convection of laminar flow(10⁴<GrPr<10⁹) at atmospheric pressure are expressed including an upward extension, a male snapping member on the top of the extension, a well on a front, a threaded hole on a rear, and an aperture through
(2-4) vertical plane palate
h₀=1.42{(T₀−T_{g})/lₛ}^{¼}
h₁=1.42{(T_{g}−T₁)/lₛ}^{¼}
hₛ=1.42{(Tₛ−Tᵢ)/lₛ}^{¼}
(2-5) horizontal column
h_{f}=1.32{(Tₛ−Tᵢ)/(2r_{f})}^{¼}
(2-6) efficiency of the fin
Ö=tanh Uₚ/U_{b}
U_{b}=2^{½}l_{f}{h_{f}/Kₛr_{f})}^{½}
(2-7) setting of parameters
q=2W, Tᵢ=15degC, Kₛ=204W/mK(at20degC), C_{g}=1000J/KgK(at 300K)
ó_{g}=1.18 kg/m³ (at 300 K)
l₀=l₁=lₛ=0.1 m,
A₀=0.014 m², r_{f}=0.001 m,l_{f}=0.005 m,t=0.001 m,n=160
vₕ=0.002 m/s
Aₕ=(0.01×0.003×80)/(0.14×0.1)×A₀=0.171A₀=0.0024 m²
A₁=Aₛ=A₀−Aₕ=0.0116 m²
A_{f}=πr^{f}_{f}⁺²+2πrl_{f}=3.46×10⁻⁵m²
(2-8) basic calculation a male snapping member, and a screw wherein the male snapping member of
(calculation of heat transfer coefficient)
Assuming (Tₛ−Tᵢ)=14degC, hₛ=1.42{(Tₛ−T₁)/(l₁)}^{¼}=4.88 W/m²K
